(19) United States
(12) Patent Application Publication
(10) Pub. No.: US 2026/0361621 A1
(43) Pub. Date: Nov. 12, 2026

(54) GENERATING CUSTOMER IMPACT SCORES ASSOCIATED WITH NETWORK FAULTS

(71) Applicant: Juniper Networks, Inc., Sunnyvale, CA (US)

(72) Inventors: Harsha LAKSHMIKANTH, Bangalore (IN); Per Anders BERGSTEN, Gammelstad (SE); Vijay Kumar GADDE, Bangalore (IN); Sri Ram SANKAR, Bangalore (IN)

(21) Appl. No.: 19/201,242

(22) Filed: May 7, 2025

(51) Int. Cl. H04L 41/5009; H04L 41/0681; H04L 41/5067

(52) U.S. Cl. CPC H04L 41/5009; H04L 41/0681; H04L 41/5067

(57) ABSTRACT

A device may receive customer data identifying numbers of customers utilizing a plurality of network devices and a plurality of links of a network, and may receive redundancy data identifying redundancies associated with the plurality of network devices and the plurality of links. The device may calculate a customer impact score for the network based on the customer data and the redundancy data, and may manage the network based on the customer impact score.

### BACKGROUND

Network device alarms and network device key performance indicator (KPI) health are used to track the health of network devices provided in a network.

### SUMMARY

Some implementations described herein relate to a method. The method may include receiving customer data identifying numbers of customers utilizing a plurality of network devices and a plurality of links of a network, and receiving redundancy data identifying redundancies associated with the plurality of network devices and the plurality of links. The method may include calculating a customer impact score for the network based on the customer data and the redundancy data, and managing the network based on the customer impact score.

Some implementations described herein relate to a device. The device may include one or more memories and one or more processors. The one or more processors may be configured to receive customer data identifying numbers of customers utilizing a plurality of network devices and a plurality of links of a network, and receive redundancy data identifying redundancies associated with the plurality of network devices and the plurality of links. The one or more processors may be configured to calculate a customer impact score for the network based on the customer data and the redundancy data, and manage one or more alerts associated with one or more of the plurality of network devices or one or more of the plurality of links based on the customer impact score.

Some implementations described herein relate to a non-transitory computer-readable medium that stores a set of instructions. The set of instructions, when executed by one or more processors of a device, may cause the device to receive customer data identifying numbers of customers utilizing a plurality of network devices and a plurality of links of a network, and receive redundancy data identifying redundancies associated with the plurality of network devices and the plurality of links. The set of instructions, when executed by one or more processors of the device, may cause the device to calculate a customer impact score for the network based on the customer data and the redundancy data, and manage one or more alerts associated with the network based on the customer impact score.

### BRIEF DESCRIPTION OF THE DRAWINGS

FIGS. 1A-1I are diagrams of an example associated with generating customer impact scores associated with network faults.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for generating customer impact scores associated with network faults.

### DETAILED DESCRIPTION

The following detailed description of example implementations refers to the accompanying drawings. The same reference numbers in different drawings may identify the same or similar elements.

Current systems may map severities of alarms and alerts to categories, such as critical, major, and minor. While the severities of alarms and alerts can change over time, current systems consider the severities of alarms and alerts in isolation and not based on a state of the network. Thus, from a severity perspective, alarms and alerts are static, isolated, and not indicative of an overall impact to the network. For example, a link failure may generate a corresponding alert. As long as there are redundant links capable of carrying traffic, this link failure can be handled. However, based on an overall network load or available links that are operational, the link failure may result in a catastrophic network failure and hence warrants a critical impact severity. Current systems offer creation of additional rules to generate new alarms based on existing alarms. However, the additional rules fail to work without user customization and are limited to a set of specific rules that have been created. Current systems also fail to prioritize multiple simultaneous high impact alarms and alerts. Thus, current techniques for handling network device alarms and alerts consume computing resources (e.g., processing resources, memory resources, communication resources, and/or the like), networking resources, and/or the like associated with failing to define severities for alarms and alerts, failing to prioritize multiple simultaneous high impact alarms and alerts, handling less severe alarms and alerts based on failing to define the severities for the alarms and alerts, handling a network failure and data loss based on failing to handle more sever alarms and alerts, and/or the like.

Some implementations described herein relate to a controller system for generating customer impact scores associated with network faults. For example, a controller system may receive customer data identifying numbers of customers utilizing a plurality of network devices and a plurality of links of a network, and may receive redundancy data identifying redundancies associated with the plurality of network devices and the plurality of links. The device may calculate a customer impact score for the network based on the customer data and the redundancy data, and may manage the network based on the customer impact score.

In this way, the controller system may generate customer impact scores associated with network faults. For example, a controller system may manage a network based on information associated with network devices and links of the network that are being utilized to service customers. The controller system may calculate customer impact scores for the network, and may utilize the customer impact scores to prioritize correcting customer impacting alerts associated with the network devices and the links non-customer impacting alerts associated with the network devices and the links. When multiple high customer impact alerts are received, the controller system may prioritize correcting the alerts with the greatest customer impact scores. Thus, the controller system may conserve computing resources, networking resources, and/or the like that would otherwise have been consumed by failing to define severities for alarms and alerts, failing to prioritize multiple simultaneous high impact alarms and alerts, handling less severe alarms and alerts based on failing to define the severities for the alarms and alerts, handling a network failure and data loss based on failing to handle more sever alarms and alerts, and/or the like.

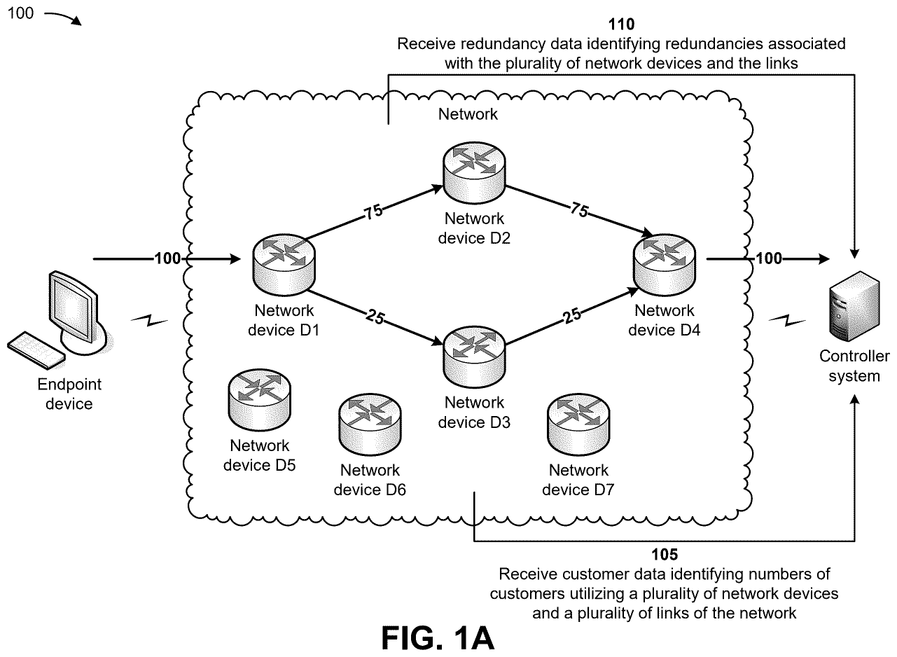

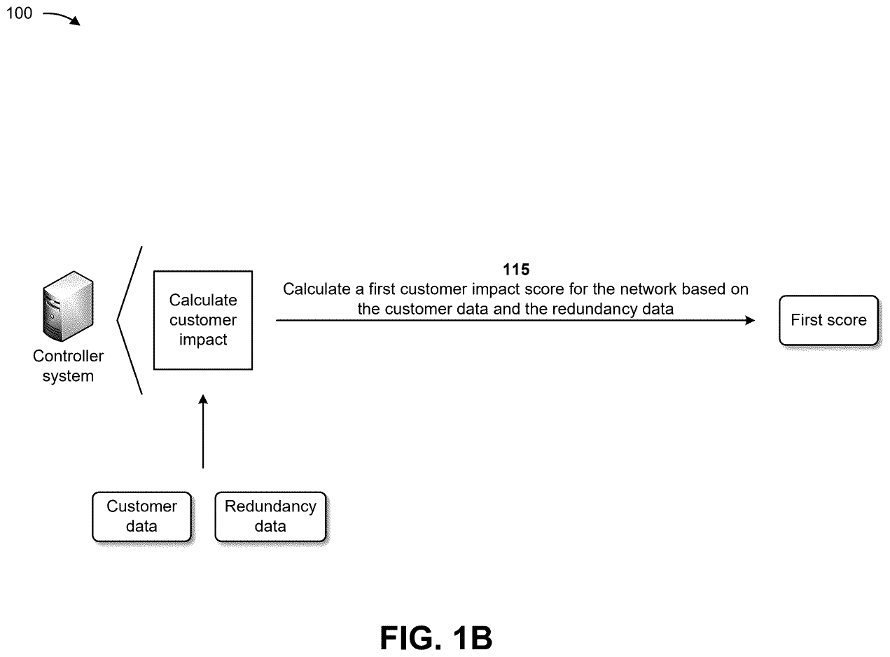

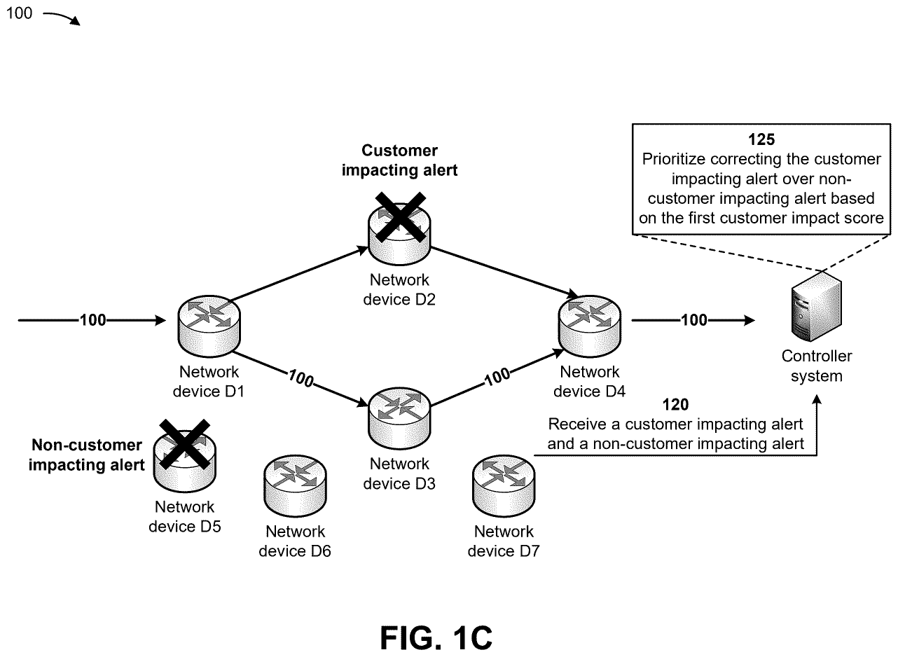

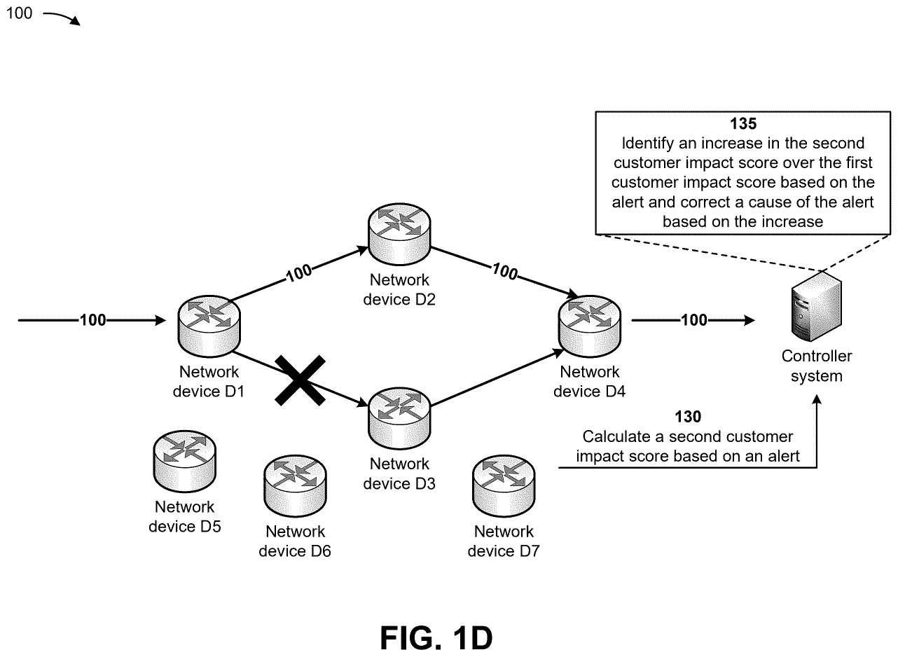

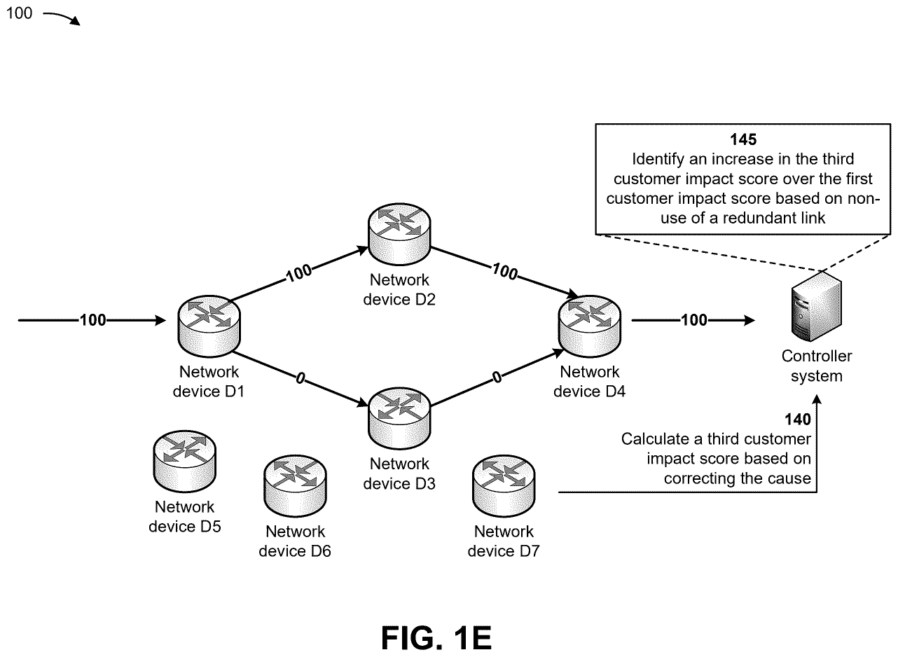

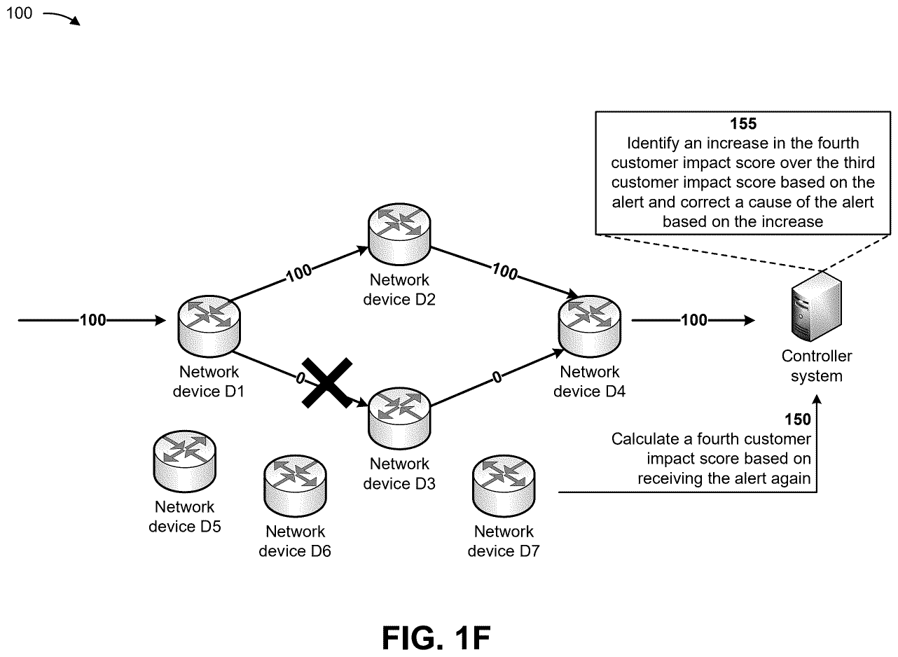

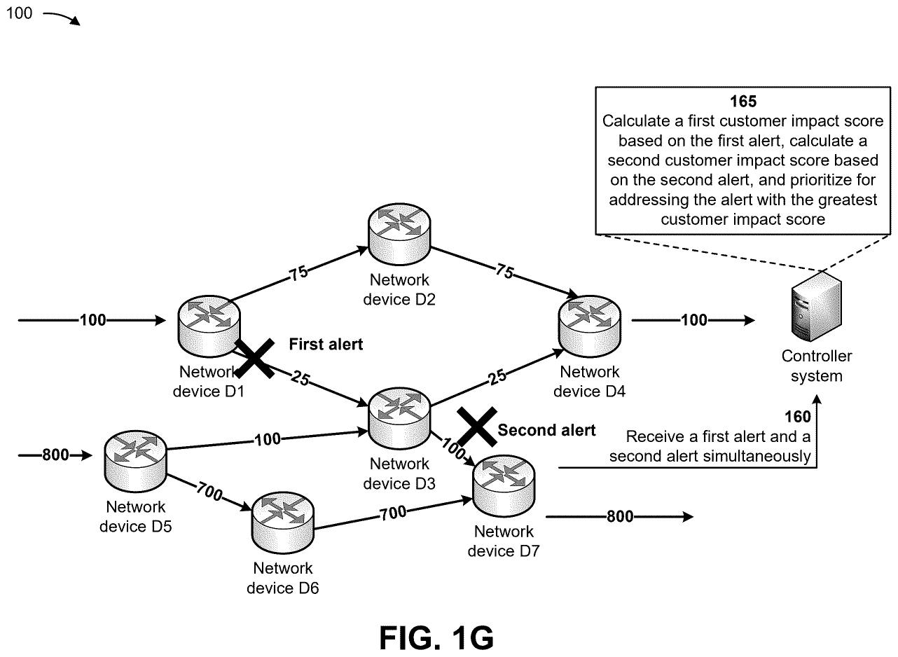

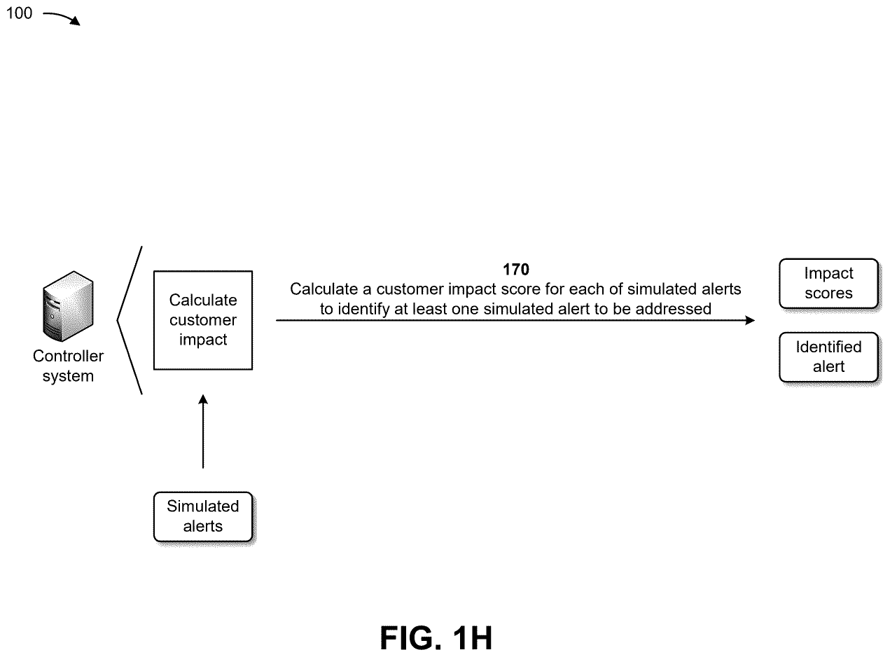

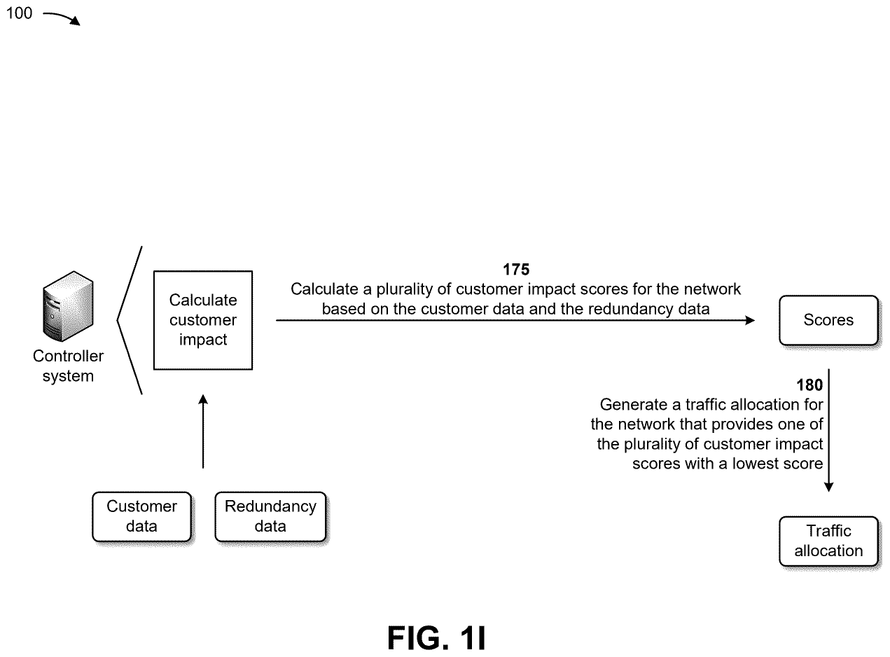

FIGS. 1A-1I are diagrams of an example 100 associated with generating customer impact scores associated with network faults. As shown in FIG. 1A, the example 100 includes an endpoint device associated with a network and a controller system. The network may include multiple network devices, such as network device D1, network device D2, network device D3, network device D4, network device D5, network device D6, and network device D7, with links provided between one or more the network devices. Further details of the endpoint device, the controller system, the network, and the network devices are provided elsewhere herein.

As shown in FIG. 1A, and by reference number 105, the controller system may receive customer data identifying numbers of customers utilizing a plurality of network devices and a plurality of links of the network. For example, the controller system may utilize network monitoring tools that are capable of collecting the customer data from various network devices. The network monitoring tools may include simple network management protocol (SNMP) agents, NetFlow, sFlow, or other telemetry protocols. Alternatively, or additionally, the controller system may periodically poll the network devices to gather the customer data or may receive unsolicited notifications when certain events occur. The customer data may include data identifying the numbers of customers utilizing the plurality of network devices and the plurality of links, the number of active sessions for customers, bandwidth usage by customers, and other metrics that indicate customer activity.

In some implementations, the controller system may integrate with customer relationship management (CRM) systems that maintain records of customer subscriptions and usage patterns. The controller system may utilize application programming interfaces (APIs) to fetch the customer data identifying the number of customers utilizing the plurality of network devices and the plurality of links. Alternatively, or additionally, the controller system may integrate with billing systems that provide insights into active customer accounts and their associated network usage. The controller system may cross-reference the billing systems data with network monitoring tools data to identify the number of customers utilizing the plurality of network devices and the plurality of links.

The controller system may aggregate the data from the multiple sources to create a comprehensive view of customer utilization. This may include combining data received from the network monitoring tools, the CRM systems, and the billing systems. The controller system may normalize the aggregated data to ensure consistency. For example, different data sources may use different units or formats, which may be standardized. In some implementations, the controller system may identifies the number of customers utilizing each network device and each link by mapping network addresses of the network devices to customer accounts.

As further shown in FIG. 1A, and by reference number 110, the controller system may receive redundancy data identifying redundancies associated with the plurality of network devices and the plurality of links. For example, the controller system may utilize topology discovery tools that map a physical and logical layout of the network. The topology discovery tools may include a link layer discovery protocol (LLDP) and other network discovery protocols. The physical and logical layout of the network may include the redundancy data identifying the redundancies associated with the plurality of network devices and the plurality of links. In some implementations, the controller system may receive the redundancy data from manual input provided by network administrators.

In some implementations, the controller system may access configuration files from the network devices that specify redundancy settings. For example, network device configurations may include details about redundant links, failover protocols, and load balancing settings. Alternatively, or additionally, the controller system may receive data from redundancy protocols such as a virtual router redundancy protocol (VRRP), a hot standby router protocol (HSRP), and a link aggregation control protocol (LACP) to understand how redundancy is implemented in the network. Alternatively, or additionally, the controller system may integrate with network management system (NMS) platforms that provide a centralized view of network configurations and redundancy setups. APIs and data feeds from NMS platforms may be utilize by the controller system used to gather the redundancy data. The controller system may analyze the collected data from the multiple sources to identify the redundancies associated with the plurality of network devices and the plurality of links. This may include determining which network devices and links have backup paths, failover mechanisms, and load-sharing capabilities.

As shown in FIG. 1B, and by reference number 115, the controller system may calculate a first customer impact score for the network based on the customer data and the redundancy data. For example, based on the redundancy, the controller system may define a redundancy (r) for each element (i) (e.g., a network device or a link). Based on the customer data, the controller system may define a number of customers (C) utilizing each element (i) and a number (n) of elements. The controller system may calculate the customer impact score (CIS) according to the following equation:

$$CIS = \frac{{\sum }_{i = 1}^{n} r ( i ) \cdot C ( i )}{{\sum }_{i = 1}^{n} C ( i )} .$$

In some implementations, the controller system may multiply each element of the customer data (C) by each element of the redundancy data (r) to generate a plurality of first values. The controller system may add the plurality of first values together to generate a second value, and may add each element of the customer data together to generate a third value. The controller system may divide the second value by the third value to generate the customer impact score (CIS) for the network. In some implementations, when there are zero customers in the network, the customer impact score (CIS) for the network may be defined as zero.

In one example, the redundancies of network devices D1-D7 may be designated as r(D1), r(D2), r(D3), r(D4), r(D5), r(D6), and r(D7); the redundancies of the links may be designated as r(D1-D2), r(D1-D3), r(D2-D4), and r(D3-D4); the number of customers associated with the network devices may be designated as C(D1), C(D2), C(D3), C(D4), C(D5), C(D6), and C(D7); and the number of customers associated with the links may be designated as C(D1-D2), C(D1-D3), C(D2-D4), and C(D3-D4). The controller system may create a first matrix for the redundancies as follows:
[r(D1) r(D2) r(D3) r(D4) r(D1-D2) r(D1-D3) r(D2-D4) r(D3-D4) r(D5) r(D6) r(D7)].
   The controller system may create a second matrix for the number of customers as follows:

$$[ \begin{matrix}C ( D 1 ) \\ C ( D 2 ) \\ C ( D 3 ) \\ C ( D 4 ) \\ C ( D 1 - D 2 ) \\ C ( D 1 - D 3 ) \\ C ( D 2 - D 4 ) \\ C ( D 3 - D 4 ) \\ C ( D 5 ) \\ C ( D 6 ) \\ C ( D 7 )\end{matrix} ] .$$

The controller system may multiple the first matrix by the second matrix to generate a plurality of first values. The controller system may add the plurality of first values together to generate a second value, and may add each element of the second matrix together to generate a third value. The controller system may divide the second value by the third value to calculate the customer impact score (CIS) for the network. For example, as shown in FIG. 1A, r(D1)=1, r(D2)=0.5, r(D3)=0.5, r(D4)=1, r(D1-D2)=0.5, r(D1-D3)=0.5, r(D2-D4)=0.5, r(D3-D4)=0.5, r(D5)=0, r(D6)=0, r(D7)=0, C(D1)=100, C(D2)=75, C(D3)=25, C(D4)=100, C(D1-D2)=75, C(D1-D3)=25, C(D2-D4)=75, C(D3-D4)=25, C(D5)=0, C(D6)=0, and C(D7)=0. With these figures, the customer impact score (CIS) for the network may be 60%.

As shown in FIG. 1C, and by reference number 120, the controller system may receive a customer impacting alert and a non-customer impacting alert. For example, network device D2 and network device D5 may become inoperable and may generate an alert. The alert generated by network device D2 may be a customer impacting alert affecting seventy-five (75) customers that are being serviced through links D1-D2 and D2-D4. The alert generated by network device D5 may be a non-customer impacting alert since no customers are being serviced through network device D5. The alerts may be generated simultaneously.

As further shown in FIG. 1C, and by reference number 125, the controller system may prioritize correcting the customer impacting alert over non-customer impacting alert based on the first customer impact score. For example, the controller system may determine that the first customer impact score (e.g., 60%) is based on network device D2 and not based on network device D5. In some implementations, since the alert generated by network device D2 impacts customers and the alert generated by network device D5 fails to impact customers, the controller system may prioritize correcting a cause of the alert generated by network device D2 over correcting a cause of the alert generated by network device D5.

As shown in FIG. 1D, and by reference number 130, the controller system may calculate a second customer impact score based on an alert. For example, a link D1-D3 may become inoperable and render network device D3 inoperable. An alert may be generated based on the link D1-D3 and network device D3 becoming inoperable. The controller system may receive the alert and may calculate a second customer impact score based on the alert. Based on the scenario of FIG. 1D, the controller system may create a first matrix for the redundancies as follows:
[r(D1) r(D2) r(D4) r(D1-D2) r(D2-D4)].
   The controller system may create a second matrix for the number of customers as follows:

$$[ \begin{matrix}C ( D 1 ) \\ C ( D 2 ) \\ C ( D 4 ) \\ C ( D 1 - D 2 ) \\ C ( D 2 - D 4 )\end{matrix} ] .$$

The controller system may multiple the first matrix by the second matrix to generate a plurality of first values. The controller system may add the plurality of first values together to generate a second value, and may add each element of the second matrix together to generate a third value. The controller system may divide the second value by the third value to calculate the customer impact score (CIS) for the network. For example, as shown in FIG. 1D, r(D1)=1, r(D2)=1, r(D4)=1, r(D1-D2)=1, r(D2-D4)=1, C(D1)=100, C(D2)=100, C(D4)=100, C(D1-D2)=100, and C(D2-D4)=100. With these figures, the customer impact score (CIS) for the network may be 100%.

As further shown in FIG. 1D, and by reference number 135, the controller system may identify an increase in the second customer impact score over the first customer impact score based on the alert and may correct a cause of the alert based on the increase. For example, the controller system may compare the first customer impact score (e.g., 60% based on FIG. 1A) and the second customer impact score (e.g., 100% based on the alert of FIG. 1D). Since the second customer impact score is greater than the first customer impact score, the controller system may identify the increase (e.g., 40% increase) in the second customer impact score over the first customer impact score. In some implementations, since the customer impact score increased to 100%, the controller system may determine that the network may be one step away from a catastrophic event. The controller system may identify the cause of the alert, and may correct the cause of the alert in order to avoid the catastrophic event. For example, the controller system may determine that the link between network device D1 and network device D3 needs to be replaced. In such an example, the controller system may dispatch a technician to replace the link.

As shown in FIG. 1E, and by reference number 140, the controller system may calculate a third customer impact score based on correcting the cause of the alert. For example, after the controller system corrects the cause of the alert, the network may be configured as shown in FIG. 1E. The controller system may generate the first matrix and the second matrix shown in FIG. 1A (e.g., omitting consideration of network devices D5, D6, and D7), and may multiple the first matrix by the second matrix to generate a plurality of first values. The controller system may add the plurality of first values together to generate a second value, and may add each element of the second matrix together to generate a third value. The controller system may divide the second value by the third value to calculate the customer impact score (CIS) for the network. For example, as shown in FIG. 1E, r(D1)=1, r(D2)=0.5, r(D3)=0.5, r(D4)=1, r(D1-D2)=0.5, r(D1-D3)=0.5, r(D2-D4)=0.5, r(D3-D4)=0.5, C(D1)=100, C(D2)=100, C(D3)=0, C(D4)=100, C(D1-D2)=100, C(D1-D3)=0, C(D2-D4)=100, and C(D3-D4)=0. With these figures, the customer impact score (CIS) for the network may be 70%, after correcting the link between network device D1 and network device D3.

As further shown in FIG. 1E, and by reference number 145, the controller system may identify an increase in the third customer impact score over the first customer impact score based on non-use of a redundant link. For example, may compare the first customer impact score (e.g., 60% based on FIG. 1A) and the third customer impact score (e.g., 70% based on the alert of FIG. 1E). Since the third customer impact score is greater than the first customer impact score, the controller system may identify the increase (e.g., 10% increase) in the third customer impact score over the first customer impact score. In some implementations, the controller system may determine that the increase is due to non-use of the redundant link provided between network device D1 and network device D3, which results in non-use of the redundant link provided between network device D3 and network device D4.

As shown in FIG. 1F, and by reference number 150, the controller system may calculate a fourth customer impact score based on receiving the alert again. For example, the link D1-D3 (e.g., even though not being utilized by customers) may become inoperable again and may render network device D3 inoperable again. The alert may be generated based on the link D1-D3 and network device D3 becoming inoperable. The controller system may receive the alert and may calculate a fourth customer impact score based on the alert. Based on the scenario of FIG. 1F, the controller system may create the first matrix and the second matrix as described above in connection with FIG. 1D. The controller system may multiple the first matrix by the second matrix to generate a plurality of first values. The controller system may add the plurality of first values together to generate a second value, and may add each element of the second matrix together to generate a third value. The controller system may divide the second value by the third value to calculate the customer impact score (CIS) for the network. For example, as shown in FIG. 1F, r(D1)=1, r(D2)=1, r(D4)=1, r(D1-D2)=1, r(D2-D4)=1, C(D1)=100, C(D2)=100, C(D4)=100, C(D1-D2)=100, and C(D2-D4)=100. With these figures, the customer impact score (CIS) for the network may be 100%.

As further shown in FIG. 1F, and by reference number 155, the controller system may identify an increase in the fourth customer impact score over the third customer impact score based on the alert and may correct a cause of the alert based on the increase. For example, the controller system may compare the third customer impact score (e.g., 70% based on FIG. 1E) and the fourth customer impact score (e.g., 100% based on the alert of FIG. 1F). Since the fourth customer impact score is greater than the third customer impact score, the controller system may identify the increase (e.g., 30% increase) in the fourth customer impact score over the third customer impact score. This may indicate that even though link D1-D3 was not handling customer traffic, link D1-D3 becoming inoperable still increased the customer impact score and needs to be corrected. In some implementations, since the customer impact score increased to 100%, the controller system may determine that the network may be one step away from a catastrophic event. The controller system may identify the cause of the alert, and may correct the cause of the alert in order to avoid the catastrophic event. For example, the controller system may determine that the link between network device D1 and network device D3 has become disconnected. In such an example, the controller system may dispatch a technician to reconnect the link.

As shown in FIG. 1G, and by reference number 160, the controller system may receive a first alert and a second alert simultaneously. For example, the network shown in FIG. 1G may include links between network devices D3, D5, D6, and D7, and the links may be associated with the number of customers shown. As shown, a first link D1-D3 may become inoperable, and a first alert may be generated based on the first link D1-D3 becoming inoperable. A second link D3-D7 may become inoperable, and a second alert may be generated based on the second link D3-D7 becoming inoperable. The first alert and the second alert may be simultaneously received by the controller system. Thus, the controller system may decide which alert to handle first.

As further shown in FIG. 1G, and by reference number 165, the controller system may calculate a first customer impact score based on the first alert, may calculate a second customer impact score based on the second alert, and may prioritize addressing the alert with the greatest customer impact score. For example, the controller system may create a first matrix for the redundancies for the first alert (e.g., assuming the second link D3-D7 is operational) as follows:
[r(D1) r(D2) r(D4) r(D1-D2) r(D2-D4) r(D5) r(D3) r(D6) r(D7) r(D5-D3) r(D5-D6) r(D3-D7) r(D6-D7)].
   The controller system may create a second matrix for the number of customers for the first alert (e.g., assuming the second link D3-D7 is operational) as follows:

$$[ \begin{matrix}C ( D 1 ) \\ C ( D 2 ) \\ C ( D 4 ) \\ C ( D 1 - D 2 ) \\ C ( D 2 - D 4 ) \\ C ( D 5 ) \\ C ( D 3 ) \\ C ( D 6 ) \\ C ( D 7 ) \\ C ( D 5 - D 3 ) \\ C ( D 5 - D 6 ) \\ C ( D 3 - D 7 ) \\ C ( D 6 - D 7 )\end{matrix} ]$$

The controller system may multiple the first matrix by the second matrix to generate a plurality of first values. The controller system may add the plurality of first values together to generate a second value, and may add each element of the second matrix together to generate a third value. The controller system may divide the second value by the third value to calculate the customer impact score (CIS) for the network. For example, as shown in FIG. 1G, r(D1)=1, r(D2)=1, r(D4)=1, r(D1-D2)=1, r(D2-D4)=1, r(D5)=1, r(D3)=1, r(D6)=1, r(D7)=1, r(D5-D3)=0.5, r(D5-D6)=0.5, r(D3-D7)=0.5, r(D6-D7)=0.5, C(D1)=100, C(D2)=100, C(D4)=100, C(D1-D2)=100, C(D2-D4)=100, C(D5)=800, C(D3)=100, C(D6)=700, C(D7)=800, C(D5-D3)=100, C(D5-D6)=700, C(D3-D7)=100, and C(D6-D7)=700. With these figures, the first customer impact score (CIS) for the network may be 82.2%.

The controller system may create a first matrix for the redundancies for the second alert (e.g., assuming the first link D1-D3 is operational) as follows:
[r(D1) r(D2) r(D3) r(D4) r(D1-D2) r(D1-D3) r(D2-D4) r(D3-D4) r(D5) r(D6) r(D7) r(D5-D6) r(D6-D7)].
   The controller system may create a second matrix for the number of customers for the second alert (e.g., assuming the first link D1-D3 is operational) as follows:

$$[ \begin{matrix}C ( D 1 ) \\ C ( D 2 ) \\ C ( D 3 ) \\ C ( D 4 ) \\ C ( D 1 - D 2 ) \\ C ( D 1 - D 3 ) \\ C ( D 2 - D 4 ) \\ C ( D 3 - D 4 ) \\ C ( D 5 ) \\ C ( D 6 ) \\ C ( D 7 ) \\ C ( D 5 - D 6 ) \\ C ( D 6 - D 7 )\end{matrix} ]$$

The controller system may multiple the first matrix by the second matrix to generate a plurality of first values. The controller system may add the plurality of first values together to generate a second value, and may add each element of the second matrix together to generate a third value. The controller system may divide the second value by the third value to calculate the customer impact score (CIS) for the network. For example, as shown in FIG. 1G, r(D1)=1, r(D2)=0.5, r(D3)=0.5, r(D4)=1, r(D1-D2)=0.5, r(D1-D3)=0.5, r(D2-D4)=0.5, r(D3-D4)=0.5, r(D5)=1, r(D6)=1, r(D7)=1, r(D5-D6)=1, r(D6-D7)=1, C(D1)=100, C(D2)=75, C(D3)=25, C(D4)=100, C(D1-D2)=75, C(D1-D3)=25, C(D2-D4)=75, C(D3-D4)=25, C(D5)=800, C(D6)=800, C(D7)=800, C(D5-D6)=800, and C(D6-D7)=800. With these figures, the second customer impact score (CIS) for the network may be 96.7%.

The controller system may compare the first customer impact score (e.g., 82.2%) and the second customer impact score (e.g., 96.7%). Since the second customer impact score is greater than the first customer impact score, the controller system may determine that handling the cause of the second alert should be prioritized over handling the cause of the first alert. The controller system may identify the cause of the second alert, and may correct the cause of the second alert. For example, the controller system may determine that the link between network device D3 and network device D7 has become disconnected. In such an example, the controller system may dispatch a technician to reconnect the link.

As further shown in FIG. 1H, and by reference number 170, the controller system may calculate a customer impact score for each of simulated alerts to identify at least one simulated alert to be addressed. For example, the controller system may cause multiple alerts to be simulated in the network by simulating one or more network devices becoming inoperable or by simulating one or more links becoming inoperable. In some implementations, the controller system may calculate the customer impact score for each of the simulated results, and may analyze the customer impact scores. Based on the analysis of the customer impact scores, the controller system may identify a simulated alert that needs to be addressed (e.g., an alert associated with the greatest customer impact score). In some implementations, the controller system may utilize a Monte Carlo simulation to identify the simulated alert that needs to be addressed.

As shown in FIG. 1I, and by reference number 175, the controller system may calculate a plurality of customer impact scores for the network based on the customer data and the redundancy data. For example, the controller system may calculate a customer impact score for each portion of the network based on the customer data and the redundancy data, may calculate customer impact scores for the network during different time periods, and/or the like. This may generate a plurality of customer impact scores the correspond to different portions of the network, that correspond to the different time periods, and/or the like.

As further shown in FIG. 1I, and by reference number 180, the controller system may generate a traffic allocation for the network that provides one of the plurality of customer impact scores with a lowest score. For example, the controller system may identify a lowest customer impact score from the plurality of customer impact scores. In some implementations, the lowest customer impact score may be associated with a particular portion of the network, a particular time period, and/or the like. The controller system may determine the traffic allocation for the particular portion of the network, for the particular time period, and/or the like. For example, the controller system may determine that traffic should be allocated to the particular portion of the network. In another example, the controller system may determine that traffic should be allocated to the network during the particular time period.

In this way, the controller system may generate customer impact scores associated with network faults. For example, a controller system may manage a network based on information associated with network devices and links of the network that are being utilized to service customers. The controller system may calculate customer impact scores for the network, and may utilize the customer impact scores to prioritize correcting customer impacting alerts associated with the network devices and the links non-customer impacting alerts associated with the network devices and the links. When multiple high customer impact alerts are received, the controller system may prioritize correcting the alerts with the greatest customer impact scores. Thus, the controller system may conserve computing resources, networking resources, and/or the like that would otherwise have been consumed by failing to define severities for alarms and alerts, failing to prioritize multiple simultaneous high impact alarms and alerts, handling less severe alarms and alerts based on failing to define the severities for the alarms and alerts, handling a network failure and data loss based on failing to handle more sever alarms and alerts, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

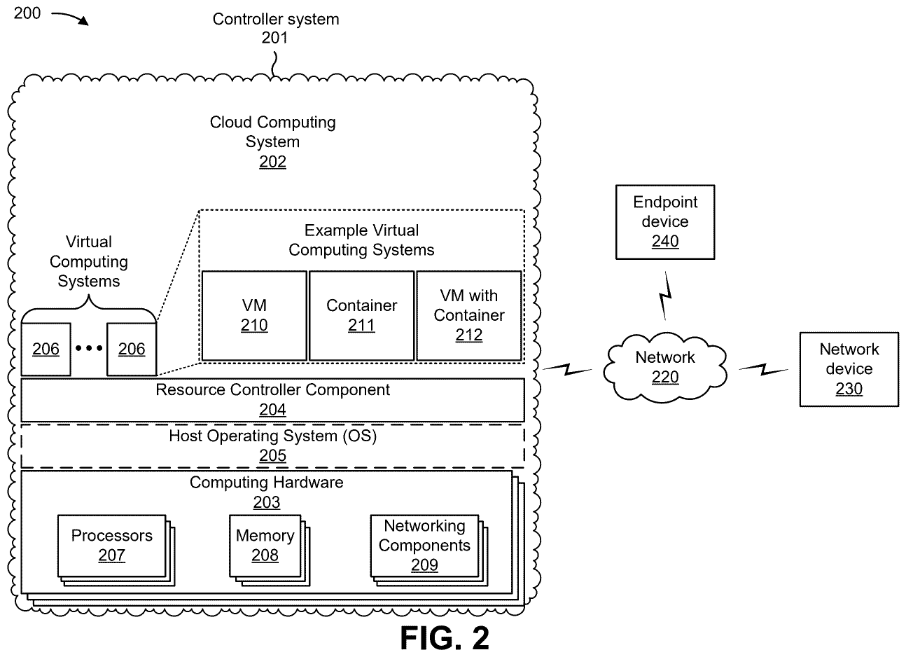

FIG. 2 is a diagram of an example environment 200 in which systems and/or methods described herein may be implemented. As shown in FIG. 2, the environment 200 may include a controller system 201, which may include one or more elements of and/or may execute within a cloud computing system 202. The cloud computing system 202 may include one or more elements 203-212, as described in more detail below. As further shown in FIG. 2, the environment 200 may include a network 220, a network device 230, and/or an endpoint device 240. Devices and/or elements of the environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as the computing hardware 203) capable of virtualizing the computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using the computing hardware 203. As shown, the virtual computing system 206 may include a virtual machine 210, a container 211, or a hybrid environment 212 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

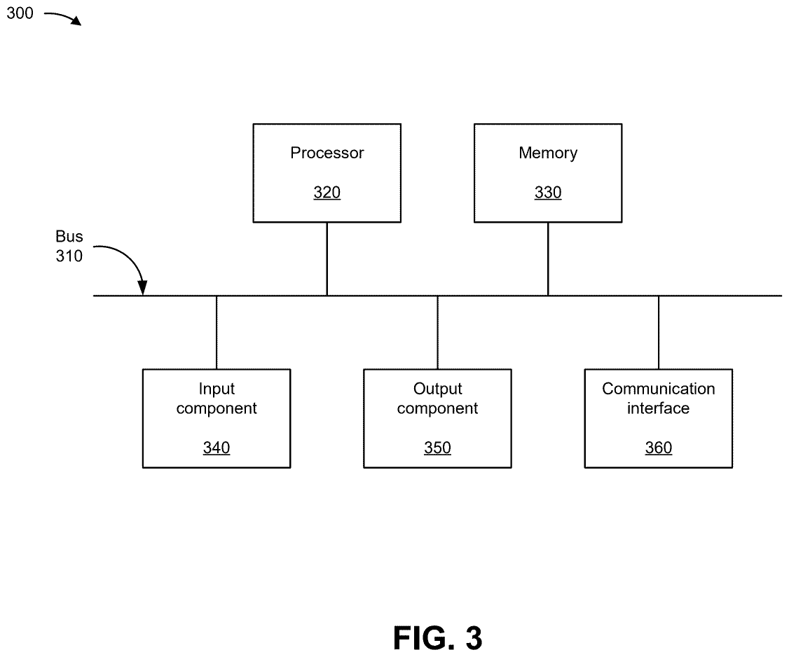

Although the controller system 201 may include one or more elements 203-212 of the cloud computing system 202, may execute within the cloud computing system 202, and/or may be hosted within the cloud computing system 202, in some implementations, the controller system 201 may not be cloud-based (e.g., may be implemented outside of a cloud computing system) or may be partially cloud-based. For example, the controller system 201 may include one or more devices that are not part of the cloud computing system 202, such as a device 300 of FIG. 3, which may include a standalone server or another type of computing device. The controller system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The network device 230 may include one or more devices capable of receiving, processing, storing, routing, and/or providing traffic (e.g., a packet and/or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computing devices of a cloud computing environment or a data center. In some implementations, a group of network devices 230 may be a group of data center nodes that are used to route traffic flow through a network.

The endpoint device 240 may include one or more devices capable of receiving, generating, storing, processing, and/or providing information, as described elsewhere herein. The endpoint device 240 may include a communication device and/or a computing device. For example, the endpoint device 240 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of one or more devices of FIG. 2. The example components may be included in a device 300, which may correspond to the controller system 201, the network device 230, and/or the endpoint device 240. In some implementations, the controller system 201, the network device 230, and/or the endpoint device 240 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

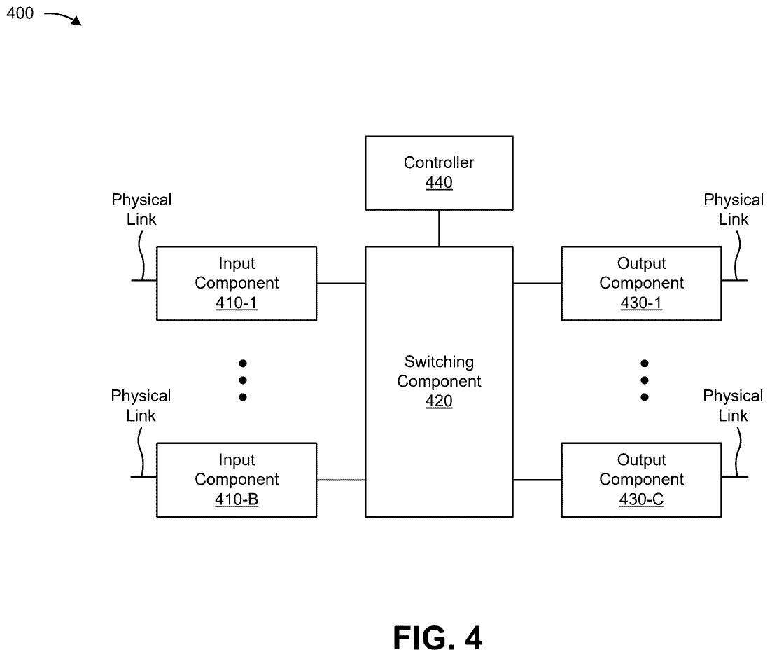

FIG. 4 is a diagram of example components of one or more devices of FIG. 2. The example components may be included in a device 400. The device 400 may correspond to the network device 230. In some implementations, the network device 230 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

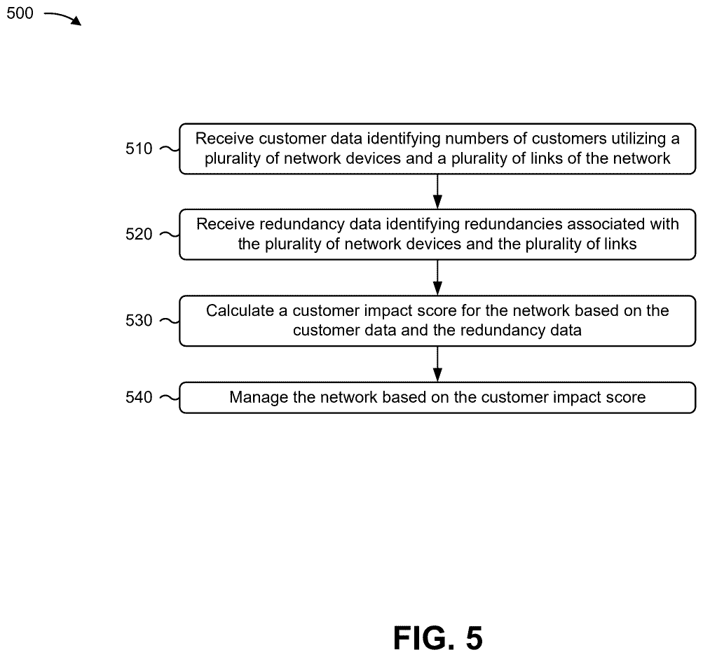

FIG. 5 is a flowchart of an example process 500 for generating customer impact scores associated with network faults. In some implementations, one or more process blocks of FIG. 5 may be performed by a device (e.g., the controller system 201). In some implementations, one or more process blocks of FIG. 5 may be performed by another device or a group of devices separate from or including the device, such as an endpoint device (e.g., the endpoint device 240) and/or a network device (e.g., the network device 230). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving customer data identifying numbers of customers utilizing a plurality of network devices and a plurality of links of the network (block 510). For example, the device may receive customer data identifying numbers of customers utilizing a plurality of network devices and a plurality of links of a network, as described above.

As further shown in FIG. 5, process 500 may include receiving redundancy data identifying redundancies associated with the plurality of network devices and the plurality of links (block 520). For example, the device may receive redundancy data identifying redundancies associated with the plurality of network devices and the plurality of links, as described above.

As further shown in FIG. 5, process 500 may include calculating a customer impact score for the network based on the customer data and the redundancy data (block 530). For example, the device may calculate a customer impact score for the network based on the customer data and the redundancy data, as described above. In some implementations, calculating the customer impact score for the network based on the customer data and the redundancy data includes multiplying each element of the customer data by each element of the redundancy data to generate a plurality of first values, adding the plurality of first values together to generate a second value, adding each element of the customer data together to generate a third value, and dividing the second value by the third value to generate the customer impact score for the network.

As further shown in FIG. 5, process 500 may include managing the network based on the customer impact score (block 540). For example, the device may manage the network based on the customer impact score, as described above.

In some implementations, the customer impact score is a first customer impact score and process 500 includes calculating a second customer impact score based on an alert associated with the network, identifying an increase in the second customer impact score over the first customer impact score based on the alert, and correcting a cause of the alert based on the increase in the second customer impact score over the first customer impact score. In some implementations, process 500 includes calculating a third customer impact score based on correcting the cause of the alert, and identifying an increase in the third customer impact score over the first customer impact score based on non-use of a redundant link of the plurality of links. In some implementations, process 500 includes calculating a fourth customer impact score based on receiving the alert again, identifying an increase in the fourth customer impact score over the third customer impact score based on the alert, and correcting a cause of the alert based on the increase in the fourth customer impact score over the third customer impact score.

In some implementations, process 500 includes receiving a first alert and a second alert simultaneously, calculating a first customer impact score based on the first alert, calculating a second customer impact score based on the second alert, and determining whether the first customer impact score is greater than the second customer impact score. In some implementations, process 500 includes prioritizing the first alert when the first customer impact score is greater than the second customer impact score. In some implementations, process 500 includes prioritizing the second alert when the second customer impact score is greater than the first customer impact score.

In some implementations, process 500 includes receiving a customer impacting alert and a non-customer impacting alert associated with the network, and prioritizing correction of the customer impacting alert over the non-customer impacting alert based on the customer impact score. In some implementations, process 500 includes generating a notification indicating to correct the customer impacting alert, and providing the notification for display.

In some implementations, process 500 includes generating simulated alerts for the network, and calculating respective customer impact scores for each of the simulated alerts, and identifying at least one simulated alert to be addressed based on the respective customer impact scores. In some implementations, identifying the at least one simulated alert to be addressed includes utilizing a Monte Carlo simulation to identify the at least one simulated alert to be addressed.

In some implementations, process 500 includes calculating a plurality of customer impact scores for the network based on the customer data and the redundancy data, identifying one of the plurality of customer impact scores with a lowest score, and generating a traffic allocation for the network based on the one of the plurality of customer impact scores.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, customer data identifying numbers of customers utilizing a plurality of network devices and a plurality of links of a network;
receiving, by the device, redundancy data identifying redundancies associated with the plurality of network devices and the plurality of links;
calculating, by the device, a customer impact score for the network based on the customer data and the redundancy data; and
managing, by the device, the network based on the customer impact score.

2. The method of claim 1, wherein the customer impact score is a first customer impact score and the method further comprises:
calculating a second customer impact score based on an alert associated with the network;
identifying an increase in the second customer impact score over the first customer impact score based on the alert; and
correcting a cause of the alert based on the increase in the second customer impact score over the first customer impact score.

3. The method of claim 2, further comprising:
calculating a third customer impact score based on correcting the cause of the alert; and
identifying an increase in the third customer impact score over the first customer impact score based on non-use of a redundant link of the plurality of links.

4. The method of claim 3, further comprising:
calculating a fourth customer impact score based on receiving the alert again;
identifying an increase in the fourth customer impact score over the third customer impact score based on the alert; and
correcting a cause of the alert based on the increase in the fourth customer impact score over the third customer impact score.

5. The method of claim 1, further comprising:
receiving a first alert and a second alert simultaneously;
calculating a first customer impact score based on the first alert;
calculating a second customer impact score based on the second alert; and
determining whether the first customer impact score is greater than the second customer impact score.

6. The method of claim 5, further comprising:
prioritizing the first alert when the first customer impact score is greater than the second customer impact score.

7. The method of claim 5, further comprising:
prioritizing the second alert when the second customer impact score is greater than the first customer impact score.

8. A device, comprising:
one or more memories; and
one or more processors to:
receive customer data identifying numbers of customers utilizing a plurality of network devices and a plurality of links of a network;
receive redundancy data identifying redundancies associated with the plurality of network devices and the plurality of links;
calculate a customer impact score for the network based on the customer data and the redundancy data; and
manage one or more alerts associated with one or more of the plurality of network devices or one or more of the plurality of links based on the customer impact score.

9. The device of claim 8, wherein the one or more processors are further to:
receive a customer impacting alert and a non-customer impacting alert associated with the network; and
prioritize correction of the customer impacting alert over the non-customer impacting alert based on the customer impact score.

10. The device of claim 9, wherein the one or more processors are further to:
generate a notification indicating to correct the customer impacting alert; and
provide the notification for display.

11. The device of claim 8, wherein the one or more processors are further to:
generate simulated alerts for the network; and
calculate respective customer impact scores for each of the simulated alerts; and
identify at least one simulated alert to be addressed based on the respective customer impact scores.

12. The device of claim 11, wherein the one or more processors, to identify the at least one simulated alert to be addressed, are to:
utilize a Monte Carlo simulation to identify the at least one simulated alert to be addressed.

13. The device of claim 8, wherein the one or more processors are further to:
calculate a plurality of customer impact scores for the network based on the customer data and the redundancy data;
identify one of the plurality of customer impact scores with a lowest score; and
generate a traffic allocation for the network based on the one of the plurality of customer impact scores.

14. The device of claim 8, wherein the one or more processors, to calculate the customer impact score for the network based on the customer data and the redundancy data, are to:
multiply each element of the customer data by each element of the redundancy data to generate a plurality of first values;
add the plurality of first values together to generate a second value;
add each element of the customer data together to generate a third value; and
divide the second value by the third value to generate the customer impact score for the network.

15. A non-transitory computer-readable medium storing a set of instructions, the set of instructions comprising:
one or more instructions that, when executed by one or more processors of a device, cause the device to:
receive customer data identifying numbers of customers utilizing a plurality of network devices and a plurality of links of a network;
receive redundancy data identifying redundancies associated with the plurality of network devices and the plurality of links;
calculate a customer impact score for the network based on the customer data and the redundancy data; and
manage one or more alerts associated with the network based on the customer impact score.

16. The non-transitory computer-readable medium of claim 15, wherein the customer impact score is a first customer impact score and the one or more instructions further cause the device to:
calculate a second customer impact score based on an alert associated with the network;
identify an increase in the second customer impact score over the first customer impact score based on the alert; and
correct a cause of the alert based on the increase in the second customer impact score over the first customer impact score.

17. The non-transitory computer-readable medium of claim 15, wherein the one or more instructions further cause the device to:
receive a first alert and a second alert simultaneously;
calculate a first customer impact score based on the first alert;
calculate a second customer impact score based on the second alert; and
determine whether the first customer impact score is greater than the second customer impact score.

18. The non-transitory computer-readable medium of claim 17, wherein the one or more instructions further cause the device to selectively:
prioritize the first alert when the first customer impact score is greater than the second customer impact score; or
prioritize the second alert when the second customer impact score is greater than the first customer impact score.

19. The non-transitory computer-readable medium of claim 15, wherein the one or more instructions further cause the device to:
receive a customer impacting alert and a non-customer impacting alert associated with the network;
prioritize correction of the customer impacting alert over the non-customer impacting alert based on the customer impact score;
generate a notification indicating to correct the customer impacting alert; and
provide the notification for display.

20. The non-transitory computer-readable medium of claim 15, wherein the one or more instructions further cause the device to:
calculate a plurality of customer impact scores for the network based on the customer data and the redundancy data;
identify one of the plurality of customer impact scores with a lowest score; and
generate a traffic allocation for the network based on the one of the plurality of customer impact scores.
